(19) United States
(12) Patent Application Publication
(10) Pub. No.: US 2019/0299224 A1
(43) Pub. Date: Oct. 3, 2019

(54) Shower structure

(71) Applicants: CHIN-LUNG WU, Taichung City (TW); WEI-SHENG WU, New Taipei City (TW)

(72) Inventors: CHIN-LUNG WU, Taichung City (TW); WEI-SHENG WU, New Taipei City (TW)

(21) Appl. No.: 15/939,179

(22) Filed: Mar. 28, 2018

(51) Int. Cl. B05B 1/18; B05B 1/16

(52) U.S. Cl. CPC B05B 1/185; A47K 3/281; B05B 1/16

(57) ABSTRACT

A shower structure includes a shower head and a water intake hose. The shower head has a head portion and a first positioning means disposed on a side of the shower head without a water output panel, and a water outlet of the water intake hose is connected to an end of a handle of the shower head by a connecting hose, and the water intake hose has a second positioning means disposed on a side facing the first positioning means and provided for connecting the first positioning means, so that the shower structure not just has very few components and facilitates users to assemble the structure only, but also requires no separate hanger design to improve the aesthetic appearance of the shower space.

### FIELD OF THE INVENTION

The present disclosure relates to a shower structure, in particular to the shower structure provided for hooking and hanging a shower head.

### BACKGROUND OF THE INVENTION

In general, a conventional shower head is provided for a user to hold by a hand to achieve the effect of taking a shower. Users have to spare a hand to hold the shower head, while using the other hand to wash their body. Obviously, such application is inconvenient. Therefore, the shower head is usually equipped with a shower holder fixed onto a wall, and the holder is provided for holding or hanging the shower head, so that the users can wash their body by both hands.

As disclosed in R.O.C. Pat. No. M289781 entitled “A rotary positioning shower head hanger”, the rotary positioning shower head hanger comprises a holder, a movable seat, an elastic positioning member and a screw, wherein the holder is fixed onto a wall, and a cooperating seat disposed at the front of the holder, and a locking body is installed on an inner side of the cooperating seat, and a plugging slot is formed at the front of the movable seat and provided for plugging and fixing a shower head, so that the shower head can be plugged and the plugging angle of the shower head can be adjusted conveniently.

Although the conventional structure can achieve the effect of plugging the shower head for use, the structure has many components and it is inconvenient for users to assemble the shower structure. In addition, a conventional standard hanger design also affects the overall aesthetic appearance of the shower space. Obviously, the conventional shower structure requires improvements.

### SUMMARY OF THE INVENTION

Therefore, it is a primary objective of the present invention to overcome the aforementioned drawbacks by providing a shower structure with the features of having very few components to facilitate assembling the structure, requiring no separate hanger design, and improving the overall aesthetic appearance of the shower space.

To achieve the aforementioned and other objectives, the present invention provides a shower structure, comprising: a handle, a head portion disposed at an end of the handle, a water output panel disposed on a side of the head portion, and a first positioning means disposed on a side of the head portion without the water output panel; and

a water intake hose, having a water inlet and a water outlet, and the water inlet being coupled to a water source and also coupled an end of the head portion of the shower head by a connecting hose, and the water intake hose having a second positioning means facing the first positioning means and provided for coupling the first positioning means.

Wherein, the shower head has a protrusion disposed on a side without the water output panel and provided for forming the first positioning means.

Wherein, the first positioning means is a slot, and the second positioning means is a tab, and the slot is provided for plugging and receiving the tab.

Wherein, the first positioning means is a tab, and the second positioning means is a slot, and the tab is plugged and received in the slot.

### BRIEF DESCRIPTION OF THE DRAWINGS

FIG. 1 is a perspective view of this disclosure;

FIG. 2 is an exploded view of this disclosure;

FIG. 3 is another exploded view of this disclosure; and

FIG. 4 is a partial cross-sectional view of this disclosure.

### DESCRIPTION OF THE PREFERRED EMBODIMENTS

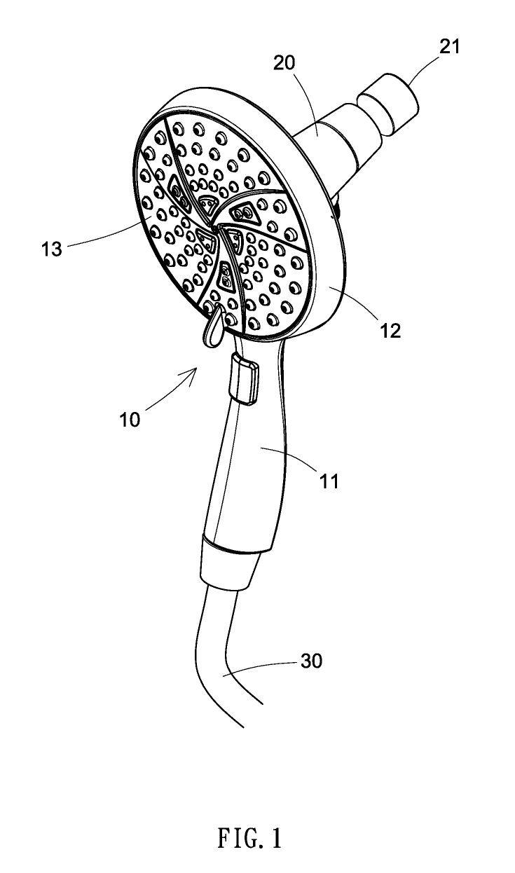

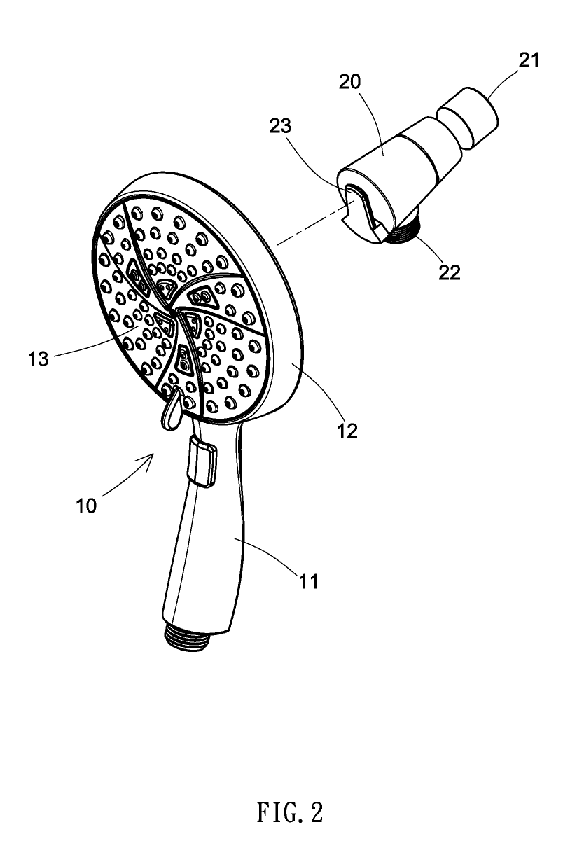

With reference to FIGS. 1 to 4 for a shower structure of this disclosure, the shower structure comprises:

a shower head 10, having a handle 11, a head portion 12 disposed at an end of the handle 11, a water output panel 13 disposed on a side of the head portion 12, and a first positioning means disposed on a side of the head portion 12 without the water output panel 13; and

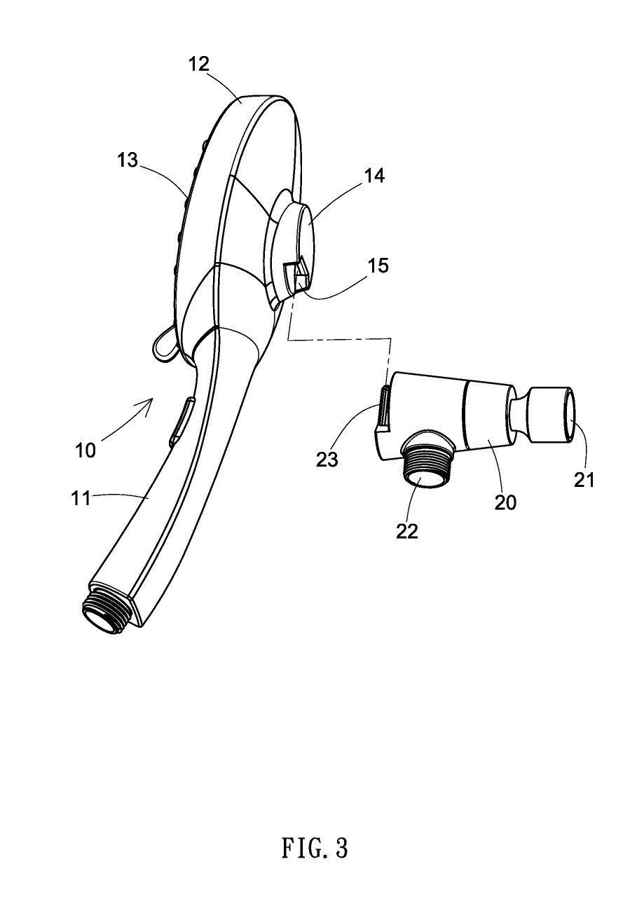

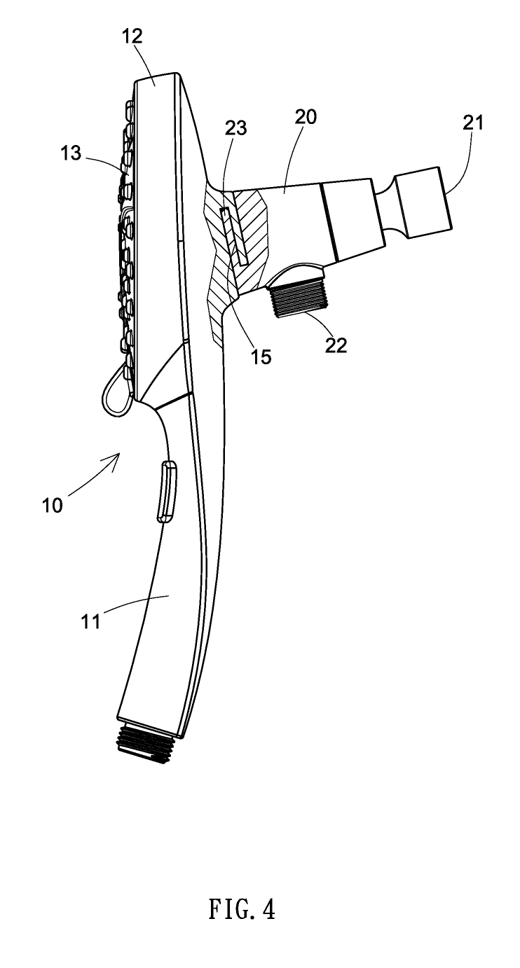

a water intake hose 20, having a water inlet 21 and a water outlet 22, and the water inlet 21 being coupled to a water source (not shown in the figure), and also to an end of the handle 11 of the shower head 10 by a connecting hose 30, and the water intake hose 20 having a second positioning means disposed on a side facing the first positioning means and provided for coupling the first positioning means.

Wherein, the shower head 10 has a protrusion 14 disposed on a side without the water output panel 13 and provided for forming the first positioning means.

Wherein, the first positioning means is a slot 15, and the second positioning means is a tab 23, and the slot 15 is provided for plugging and receiving the tab 23 (as shown in FIGS. 3 and 4).

Wherein, the first positioning means is a tab (not shown in the figure), and the second positioning means is a slot (not shown in the figure), and the tab is plugged and received in the slot.

In FIGS. 1 to 4, the shower structure of this disclosure is formed by the aforementioned simple components which are easy to installed, and the first positioning means of this embodiment is a slot 15, and the second positioning means is a tab 23. When the shower head 10 is not in use, the shower head 10 is hung at the water intake hose 20, so that the slot 15 of the shower head 10 can be provided for plugging and receiving the tab 23 of the water intake hose 20 (as shown in FIGS. 3 and 4). When a user is taking a shower, the user holds the shower head 10 directly, so that the slot 15 of the shower head 10 is separated from the tab 23 of the water intake hose 20, and water enters from the water inlet 21 of the tab 23, and the water entering from the water outlet 22 is provided from the connecting hose 30 of the water to the shower head 10 to achieve the showering effect. The shower structure of this disclosure has very few components to facilitate users to assemble the shower structure, and requires no separate hanger design to improve the overall aesthetic appearance of the shower space.

1. A shower structure, comprising:
a shower head, having a handle, a head portion disposed at an end of the handle, a water output panel disposed on a side of the head portion, and a first positioning means disposed on a side of the head portion without the water output panel; and a water intake hose, having a water inlet and a water outlet, and the water inlet being coupled to a water source and an end of the head portion of the shower head by a connecting hose, and the water intake hose having a second positioning means facing the first positioning means and provided for coupling the first positioning means, said first and second positioning means requiring no separate hanger design.

2. The shower structure of claim 1, wherein the shower head has a protrusion disposed on a side without the water output panel and provided for forming the first positioning means.

3. The shower structure of claim 1, wherein the first positioning means is a slot, and the second positioning means is a tab, and the slot is provided for plugging and receiving the tab.

4. The shower structure of claim 1, wherein the first positioning means is a tab, and the second positioning means is a slot, and the tab is plugged and received in the slot.
